(19) United States
(12) Patent Application Publication
(10) Pub. No.: US 2005/0022593 A1
(43) Pub. Date: Feb. 3, 2005

(54) Fluid flow sensor

(76) Inventors: Jochen Franz, Reutlingen (DE); Matthias Fuertsch, Gomaringen (DE); Stefan Finkbeiner, Gomaringen (DE); Stefan Weiss, Tuebingen (DE); Axel Kaschner, Reutlingen (DE)

Correspondence Address: KENYON & KENYON, ONE BROADWAY, NEW YORK, NY, 10004, US

(21) Appl. No.: 10/900,695

(22) Filed: Jul. 27, 2004

(30) Foreign Application Priority Data
Jul. 28, 2003 (DE) 103 34 239.7

(51) Int. Cl. G01F 1/68

(52) U.S. Cl. 73/204.26

(57) ABSTRACT

In a micromechanical sensor and/or a method for manufacturing a micromechanical sensor for detecting a state variable of a substance, the sensor includes at least one heating element, one temperature measuring element and optionally an inlet opening into and/or an outlet opening out of the cavity for this purpose. The sensor includes a cavity configured to at least partially receive the substance through one of the inlet openings and discharge it again at least partially through one of the outlets or outlet openings. The at least one state variable of the substance is detected here as a function of at least one variable representing the operation of the at least one heating element and/or the operation of the at least one temperature element.

### CROSS-REFERENCE TO RELATED APPLICATIONS

The present application claims priority to Application No. 103 34 239.7, filed in the Federal Republic of Germany on Jul. 28, 2003, which is expressly incorporated herein in its entirety by reference thereto.

### FIELD OF THE INVENTION

The present invention is directed to a micromechanical sensor and a method for manufacturing a micromechanical sensor for detecting a state variable of a substance.

### BACKGROUND INFORMATION

The present application describes a flow rate sensor and the manufacture of such a flow rate sensor based on the principle of the micromechanical air mass sensor that is capable of detecting extremely low flow rates. The basic functioning of such flow rate sensors is believed to be described in German Published Patent Application No. 42 28 484, German Published Patent Application No. 101 17 486 and German Published Patent Application No. 40 12 080, for example.

A device for determining the flow rate of a fluid medium according to the differential pressure principle is described in German Published Patent Application No. 43 08 313, for example, where a throttle is configured as a relatively long throttle tube having a relatively large inside diameter, the tube length and the inside diameter being determined so that, to achieve the predetermined total flow resistance, the frictional resistance due to the length in the throttle tube is high in comparison with its inlet resistance due to the diameter. The smallest measuring range is approximately 10 μL/min H₂O and/or 100 μL/min air.

German Published Patent Application No. 35 42 788 is believed to describe a device for thermal mass flow rate measurement of gases and liquids in pipelines, including at least two temperature-dependent thin-film resistors which are part of a bridge circuit as the measuring shunt and reference resistor, are in thermal contact with the flowing medium and at least one of which is electrically heated by a regulating circuit.

### SUMMARY

The present application describes a micromechanical sensor and a method of manufacturing a micromechanical sensor for detecting a state variable of a substance. To this end, the sensor includes at least one heating element, a temperature measuring element and optionally an inlet opening into and/or an outlet opening out of the cavity. According to an example embodiment of the present invention, the sensor includes a cavity which is configured to at least partially receive the substance through one of the inlet openings and discharge it again at least partially through one of the outlet openings. The at least one state variable of the substance is detected as a function of at least one variable representing the operation of the at least one heating element and/or the operation of the at least one temperature measuring element.

An analyzer circuit may be mounted in the micromechanical sensor and may be used to determine the state variable of the substance. In addition, in an exemplary embodiment of the present invention, the sensor is provided with a diaphragm. The at least one heating element and the at least one temperature measuring element may be arranged on this diaphragm. The state variable of the substance that is measureable by the micromechanical sensor may be the density, the temperature, the concentration, the flow velocity, the amount by volume, the amount by weight and/or the viscosity of the substance in the cavity. The substance may be liquid or gaseous. The cavity may be created by an etching operation, e.g., by KOH etching or by a trench method (DRIE). In an exemplary embodiment of the present invention, at least one of the openings which may allow an exchange of substance in the cavity may be at least partially closed.

According to an example embodiment of the present invention, the substance also flows into the cavity through the inlet opening and flows out of the cavity through the outlet opening. In addition, multiple inlet openings and/or multiple outlet openings may be provided. In an exemplary embodiment of the present invention, the substance may be guided along the diaphragm as it flows through the cavity.

In an exemplary embodiment of the present invention, the arrangement of the at least one heating element and the at least one temperature measuring element on the diaphragm is selected as a function of the direction of flow of the substance through the cavity. In particular at least one temperature measuring element is arranged downstream from at least one heating element. Alternately and/or optionally, a second temperature measuring element may also be arranged on the diaphragm upstream from the at least one heating element.

The at least one state variable may be detected as a function of variables representing the operation of the at least one heating element and/or the temperature of the at least one temperature measuring element. These variables may include, for example, a performance variable representing the triggering of the at least one heating element. However, a first temperature variable representing the temperature of a first temperature measuring element and/or a second temperature variable representing the temperature of a second temperature measuring element may also be detected. The state variable of the substance is determined as a function of at least one of these three variables.

An exemplary embodiment of the present invention takes into account the change over time of at least one of the variables thus detected in determining the state variable of the substance. For example, the time derivative of the electric current used to trigger the heating element may thus also be used as well as the time derivative of the temperature variables detected. Due to these time derivatives, more rapid changes are detectable and may be processed in comparison with the absolute values.

In an exemplary embodiment of the present invention, the sensor element includes a first part and a second part. According to an example embodiment of the present invention, the first part includes at least one semiconductor material and/or the diaphragm and/or the heating element and/or at least one temperature measuring element. The second part, however, includes glass as the material and includes at least one inlet opening and/or at least one outlet opening. The substance may be introduced into and/or removed out of the cavities through this inlet and/or outlet opening.

According to an example embodiment of the present invention, the first part of the sensor element surrounds the cavity. The cavity here is formed at least in part by the diaphragm and/or by the second part of the sensor element in that it is bordered by the diaphragm and/or the second part of the sensor element. In addition, the at least one heating element and the at least one temperature measuring element are arranged on the side of the diaphragm opposite the cavity. This may provide that the heating element and the temperature measuring element need not be provided separately with a protective layer against the substance in the cavity.

A micromechanical sensor such as that described herein may be expanded according to an example embodiment of the present invention by a device that modifies the flow rate of substance through the cavity as a function of the state variable. This may be, for example, a pump which controls the flow of substance through the cavity and/or a mechanism that closes one or more openings to achieve the desired flow rate through the cavity.

A flow rate sensor which may allow a determination of flow rate of liquids in the nL/s to mL/s range is implementable with the micromechanical sensor described here. The manufacture of this flow rate sensor may be based on the principle of the micromechanical air flow rate sensor so that it may be mass-produced inexpensively.

According to an example embodiment of the present invention, a micromechanical sensor for detecting a state variable of a substance includes: a heating element; a temperature measuring element; a cavity adapted to receive the substance; at least one of (a) an inlet opening adapted to allow at least partial filling of the cavity with the substance and (b) an outlet opening adapted to permit at least partial emptying of the cavity; and an arrangement configured to detect the state variable of the substance in the cavity as a function of at least one variable representing operation of at least one of (a) the heating element and (b) the temperature measuring element.

The micromechanical sensor may include a diaphragm.

The arrangement may include an analyzer circuit adapted to determine the state variable of the substance.

The heating element and the temperature measurement element may be arranged on a diaphragm.

The state variable may include at least one of (a) a density of the substance, (b) a temperature of the substance, (c) a concentration, (d) a flow rate of the substance, (e) an amount by volume of the substance, (f) an amount by weight of the substance and (g) a viscosity of the substance.

The substance may be one of (a) liquid and (b) gaseous.

The cavity may be formed by one of (a) an etching operation and (b) a trench operation.

At least one of (a) the inlet opening and (b) the outlet opening may be at least partially closeable.

The sensor may be adapted so that the substance flows into the cavity through the inlet opening and flows out of the cavity through the outlet opening.

The diaphragm may be configured so that the substance in the cavity is flowable along at least part of the diaphragm.

The heating element and the temperature measuring element may be arranged on a diaphragm as a function of a direction of flow of the substance. The temperature measuring element may be arranged downstream on the diaphragm, and the heating element may be arranged upstream on the diaphragm; and/or a second temperature measuring element may be arranged on the diaphragm upstream to the heating element.

The micromechanical sensor may include an arrangement configured to detect at least one of (a) a performance variable that represents a triggering of the heating element, (b) a first temperature variable that represents a temperature of a first temperature measuring element and (c) a second temperature variable that represents a temperature of a second temperature measuring element. The arrangement configured to detect the state variable may be configured to determine the state variable of the substance as a function of at least one of (a) the performance variable, (b) the first temperature variable and (c) the second temperature variable and based on a change in at least one of (a) the performance variable, (b) the first temperature variable and (c) the second temperature variable over time.

The sensor may include a first part and a second part. The first part may include at least one of (i) a semiconductor material, (ii) a diaphragm, (iii) the heating element and (iv) the temperature measuring element, the second part may include at least one of (i) glass, (ii) silicon, (iii) the inlet opening and (iv) the outlet opening.

The first part may include the cavity, and the cavity may be bordered at least partially by at least one of (a) the diaphragm and (b) the second part.

The heating element and the temperature measuring element may be arranged on a side of the diaphragm opposite the cavity.

According to an example embodiment of the present invention, a device includes a micromechanical sensor element for detecting a state variable of a substance, which includes: a heating element; a temperature measuring element; a cavity adapted to receive the substance; at least one of (a) an inlet opening adapted to allow at least partial filling of the cavity with the substance and (b) an outlet opening adapted to permit at least partial emptying of the cavity; and an arrangement configured to detect the state variable of the substance in the cavity as a function of at least one variable representing operation of at least one of (a) the heating element and (b) the temperature measuring element. The device further includes an arrangement configured to modify a flow rate of the substance through the cavity as a function of the state variable of the substance.

According to an example embodiment of the present invention, a method of manufacturing a micromechanical sensor element for detecting a state variable of a substance includes the steps of: providing at least one heating element; providing at least one temperature measuring element; providing at least one cavity adapted to accommodate the substance; providing at least one of (a) at least one inlet opening adapted to allow at least partial filling of the cavity with the substance and (b) at least one output opening adapted to allow at least partial emptying of the cavity; and providing an arrangement configured to detected the state variable of the substance in the cavity as a function of at least one variable representing operation of at least one of (a) the at least one heating element and (b) the at least one temperature measuring element.

The method may include: providing a first part including at least one of (a) a semiconductor material, (b) a diaphragm, (c) the heating element and (d) the temperature measuring element; providing a second part including at least one of (a) glass, (b) silicon, (c) the at least one inlet opening and (d) the at least one outlet opening; and joining together the first part and the second part by anodic bonding.

According to an example embodiment of the present invention, a micromechanical sensor for detecting a state variable of a substance includes: heating element means; temperature measuring means; cavity means for receiving the substance; at least one of (a) inlet opening means for allowing at least partial filling of the cavity means with the substance and (b) outlet opening means for permitting at least partial emptying of the cavity means; and means for detecting the state variable of the substance in the cavity means as a function of at least one variable representing operation of at least one of (a) the heating element means and (b) the temperature measuring means.

### BRIEF DESCRIPTION OF THE DRAWINGS

FIG. 1 shows the schematic diagram of a micromechanical sensor for detecting a state variable of a substance.

FIG. 2 shows a diagram of the temperature variation on the diaphragm in the case of a mass flow through the micromechanical sensor in FIG. 1.

### DETAILED DESCRIPTION

The desire to detect state variables of gases and/or liquids using smaller and smaller sensors results in micromechanical sensors being used to detect these variables. Conventional micromechanical sensors detect, for example, the temperature, the pressure and/or the concentration of substances. A further state variable is to be detected using an example embodiment of the present invention described below with an accuracy that was previously impossible to achieve using the sensors available on the market. This state variable is the flow, i.e., the flow rate, which thus may be detected with an accuracy in the nL range, e.g., as low as one nanoliter per second (nL/s).

To detect such a low flow rate, the principle of the micromechanical air flow rate sensor is to be used. The manufacturing and the measuring principle associated with such a micromechanical air flow rate sensor are believed to be conventional. The present description relates instead to a an exemplary embodiment that may permit a very accurate flow rate determination.

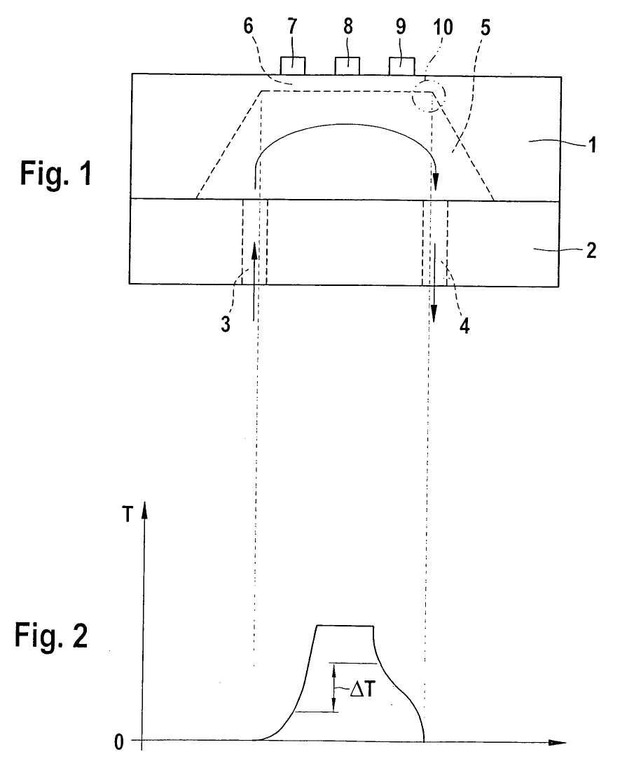

In principle, flow rates of gases and/or liquids may be determined using the configuration of the micromechanical sensor according to FIG. 1 described here. However, within the context of this description, emphasis is placed mainly on detecting flow rates of liquids for the sake of simplicity.

FIG. 1 shows a micromechanical sensor including of two parts. The first part corresponds to a conventional micromechanical air flow rate sensor 1 and the second part is a glass or silicon wafer 2 bonded to the air flow rate sensor. Micromechanical air flow rate sensor 1 may be manufactured from a semiconductor material such as silicon. As in a conventional micromechanical air flow rate sensor, a thin diaphragm 6 may be formed in the semiconductor material by an etching operation. At the same time, the etching forms a cavity 5. Cavity 5 and diaphragm 6 may be produced by KOH etching, for example, to have the typical sloping cavity walls like those illustrated in area 10. However, a high-rate trench (DRIE) process is also possible for producing the cavity, in which case vertical cavity walls are produced instead of inclined cavity walls.

To fully form the closed cavity, glass wafer 2 is bonded to air flow meter 1, e.g., by a bonding operation after the etching operation so that the quantity of liquid flowing into the cavity through inlet opening 3 in glass wafer 2 is able to flow out again only through an outlet opening 4 or a corresponding inlet opening 3. The diameter of the openings and/or through-holes 3 and 4 in glass wafer 2 may be selected according to the flow rate to be measured and thus may be preset.

If the fluid is introduced into cavity 5 through inlet openings 3 and leaves the cavity again through outlet opening 4, then the fluid flows along diaphragm 6. If heating and/or temperature measuring elements are mounted on thin diaphragm 6, as may be customary with conventional air flow rate sensors, then a change in temperature ΔT may be a measure of the flow rate. In the present exemplary embodiment according to FIG. 1, a heating element 8 and two temperature measuring elements 7 and 9 are mounted on thin diaphragm 6. Elements 7 through 9 may be mounted inside the cavity and also on the side of the diaphragm facing away from the cavity. However, the elements may not be exposed directly to the fluid flow because the liquid may negatively affect elements 7 through 9 due to the liquid in this manner. The negative effect may be caused by deposits, changes or chemical processes. One possibility for preventing such an effect would involve providing a protective layer on the elements mounted on the cavity side of the diaphragm to prevent direct contact between the elements and the fluid.

Diaphragm 6 may be configured as a dielectric diaphragm to which conductors are applied by the platinum thin-film technique in the form of heating elements 8 and/or temperature measuring elements 7 and 9. If there is no liquid flow in cavity 5, a symmetrical temperature distribution may be observed in the proximity of heating element 8. This results in an almost equal resistance value and/or an almost identical temperature on both thermocouples 7 and 9. However, when fluid flows along the diaphragm, it results in an asymmetrical temperature profile in the proximity of heating element 8, as illustrated in FIG. 2, for example. Thus the differential signal between two thermocouples 7 and 9 may be used as a measure of the quantity of fluid flowing by.

It should be pointed out, however, that the temperature of heating element 8 should be adapted to the liquid or gas. This is advisable in particular when a medication is used as the substance for which only minor temperature changes may be allowed during the measurement. In comparison with the measurement of gas quantities, however, definitely lower temperatures may be necessary with liquid quantities because liquids have a much higher thermal capacity than gases. Thus the exact configuration of the sensor depends on the specific application.

The flow channel for the liquid may be defined by openings 3 and 4 in glass wafer 2. The volume of cavity 5 and thus the minimum resolution in terms of flow rate may be determined by the thickness of the semiconductor wafer used and the configuration of cavity 5. Through a suitable choice of these parameters, flow rates in the range of nL/s may thus be resolved.

It also possible for cavity 5 to be formed not only in the first part of the micromechanical sensor but also for at least a part of cavity 5 to be formed in the second part, i.e., in glass wafer 2.

In an exemplary embodiment, multiple inlet openings 3 and/or multiple outlet openings 4 are provided in glass wafer 2. This may be used, for example, for introducing different liquids/gases into cavity 5 through different inlet openings. It is also possible that, through different outlet openings, different destinations such as vaporizers or containers may be accessed. For example, the openings may be connected via suitable valve controls in such a manner that (medical) diagnostic devices for different substances may be accessed via different inlets and outlets.

As an alternative to bonding perforated glass 2 in the rear, the flow channel may also be applied to the front side of the sensor and/or embedded in the semiconductor material of air flow rate sensor 1. It is possible to rely here on conventional surface-mounting and bonding techniques. In such an exemplary embodiment of the present invention, however, it may be important that the electric contacts to elements 7 through 9 are properly led through.

The analyzer circuit that processes the variables thus detected for the heating element and/or the at least one temperature measuring element and determines the flow rate may thus be integrated into the first part of the micromechanical sensor, e.g., implemented in a monolithic configuration in the semiconductor wafer of air flow sensor 1 as well as through an external controller.

In addition to the flow rate, additional state variables of the gas and/or liquid in cavity 5 may also be detected by the micromechanical sensor described here. For example, it is possible to determine the concentrations through a controlled variation of the temperature of heating element 8 in the case of static filling of cavity volume 5 with a substance. For example, this may be accomplished due to the fact that the correlation between the temperature recorded at one of temperature measuring elements 7 and/or 9 and the heating power on heating element 8 is a measure of the concentration within the gas and/or liquid. In addition, however, an absolute temperature measurement, a determination of viscosity and/or density is also possible.

An accurate measurement of the flow rate is used for accurate metering of extremely small quantities of fluid (sub-μL range). Electronic integration of a sensor and a valve makes it possible to control flow rates via a regulating circuit. Applications necessitating very precise measurement of the flow rates include some in the medical sector, among others. One possible application is, for example, measurement of the flow rates of cost-intensive liquid medications that are atomized and administered to the patient by inhalation.

To permit such an application of the micromechanical sensor, it is possible in another exemplary embodiment for the sensor described to be equipped with a valve and/or a pump and an atomizer. Such a device may be used for very accurate metering of liquid medications and subsequent atomization. The pump and/or the valve may be operated so that the liquid is passed through the cavity as a function of the state variable of the liquid detected. Thus, for example, it is possible to connect the at least one inlet opening 3 to the outlet of a pump. It is also possible for a steady flow of liquid through cavity 5 to be adjusted and for this flow to be modified via at least one valve on at least one opening in glass wafer 2. Vaporizers, provided in a corresponding device and, e.g., also in micromechanical form, may then be used to atomize the liquid.

1. A micromechanical sensor for detecting a state variable of a substance, comprising:
a heating element;
a temperature measuring element;
a cavity adapted to receive the substance;
at least one of (a) an inlet opening adapted to allow at least partial filling of the cavity with the substance and (b) an outlet opening adapted to permit at least partial emptying of the cavity; and
an arrangement configured to detect the state variable of the substance in the cavity as a function of at least one variable representing operation of at least one of (a) the heating element and (b) the temperature measuring element.

2. The micromechanical sensor according to claim 1, further comprising a diaphragm.

3. The micromechanical sensor according to claim 1, wherein the arrangement includes an analyzer circuit adapted to determine the state variable of the substance.

4. The micromechanical sensor according to claim 1, wherein the heating element and the temperature measurement element are arranged on a diaphragm.

5. The micromechanical sensor according to claim 1, wherein the state variable includes at least one of (a) a density of the substance, (b) a temperature of the substance, (c) a concentration, (d) a flow rate of the substance, (e) an amount by volume of the substance, (f) an amount by weight of the substance and (g) a viscosity of the substance.

6. The micromechanical sensor according to claim 1, wherein the substance is one of (a) liquid and (b) gaseous.

7. The micromechanical sensor according to claim 1, wherein the cavity is formed by one of (a) an etching operation and (b) a trench operation.

8. The micromechanical sensor according to claim 1, wherein at least one of (a) the inlet opening and (b) the outlet opening is at least partially closeable.

9. The micromechanical sensor according to claim 1, wherein the sensor is adapted so that the substance flows into the cavity through the inlet opening and flows out of the cavity through the outlet opening.

10. The micromechanical sensor according to claim 2, wherein the diaphragm is configured so that the substance in the cavity is flowable along at least part of the diaphragm.

11. The micromechanical sensor according to claim 1, wherein the heating element and the temperature measuring element are arranged on a diaphragm as a function of a direction of flow of the substance.

12. The micromechanical sensor according to claim 11, wherein at least one of (a) the temperature measuring element is arranged downstream on the diaphragm and the heating element is arranged upstream on the diaphragm and (b) a second temperature measuring element is arranged on the diaphragm upstream to the heating element.

13. The micromechanical sensor according to claim 1, further comprising an arrangement configured to detect at least one of (a) a performance variable that represents a triggering of the heating element, (b) a first temperature variable that represents a temperature of a first temperature measuring element and (c) a second temperature variable that represents a temperature of a second temperature measuring element, wherein the arrangement configured to detect the state variable is configured to determine the state variable of the substance as a function of at least one of (a) the performance variable, (b) the first temperature variable and (c) the second temperature variable and based on a change in at least one of (a) the performance variable, (b) the first temperature variable and (c) the second temperature variable over time.

14. The micromechanical sensor according to claim 1, wherein the sensor includes a first part and a second part, and wherein at least one of (a) the first part includes at least one of (i) a semiconductor material, (ii) a diaphragm, (iii) the heating element and (iv) the temperature measuring element and (b) the second part includes at least one of (i) glass, (ii) silicon, (iii) the inlet opening and (iv) the outlet opening.

15. The micromechanical sensor according to claim 14, wherein the first part includes the cavity, and the cavity is bordered at least partially by at least one of (a) the diaphragm and (b) the second part.

16. The micromechanical sensor according to claim 15, wherein the heating element and the temperature measuring element are arranged on a side of the diaphragm opposite the cavity.

17. A device, comprising:
a micromechanical sensor element for detecting a state variable of a substance, including:
a heating element;
a temperature measuring element;
a cavity adapted to receive the substance;
at least one of (a) an inlet opening adapted to allow at least partial filling of the cavity with the substance and (b) an outlet opening adapted to permit at least partial emptying of the cavity; and
an arrangement configured to detect the state variable of the substance in the cavity as a function of at least one variable representing operation of at least one of (a) the heating element and (b) the temperature measuring element; and
an arrangement configured to modify a flow rate of the substance through the cavity as a function of the state variable of the substance.

18. A method of manufacturing a micromechanical sensor element for detecting a state variable of a substance, comprising the steps of:
providing at least one heating element;
providing at least one temperature measuring element;
providing at least one cavity adapted to accommodate the substance;
providing at least one of (a) at least one inlet opening adapted to allow at least partial filling of the cavity with the substance and (b) at least one output opening adapted to allow at least partial emptying of the cavity; and
providing an arrangement configured to detected the state variable of the substance in the cavity as a function of at least one variable representing operation of at least one of (a) the at least one heating element and (b) the at least one temperature measuring element.

19. The method according to claim 9, further comprising:
providing a first part including at least one of (a) a semiconductor material, (b) a diaphragm, (c) the heating element and (d) the temperature measuring element;
providing a second part including at least one of (a) glass, (b) silicon, (c) the at least one inlet opening and (d) the at least one outlet opening; and
joining together the first part and the second part by anodic bonding.

20. A micromechanical sensor for detecting a state variable of a substance, comprising:
heating element means;
temperature measuring means;
cavity means for receiving the substance;
at least one of (a) inlet opening means for allowing at least partial filling of the cavity means with the substance and (b) outlet opening means for permitting at least partial emptying of the cavity means; and
means for detecting the state variable of the substance in the cavity means as a function of at least one variable representing operation of at least one of (a) the heating element means and (b) the temperature measuring means.
